(19) United States
(12) Patent Application Publication
(10) Pub. No.: US 2026/0276046 A1
(43) Pub. Date: Sep. 17, 2026

(54) SOLENOID ACTUATOR AND BRAKE SYSTEM COMPRISING THE SAME

(71) Applicant: HL MANDO CORPORATION, Gyeonggi-do (KR)

(72) Inventors: Dongkyun AHN, Gyeonggi-do (KR); Connor JACOBY, Auburn, MI (US)

(21) Appl. No.: 19/353,647

(22) Filed: Oct. 9, 2025

(30) Foreign Application Priority Data
Mar. 14, 2025 (KR) 10-2025-0033432

(51) Int. Cl. F16D 65/18; F16D 121/24; F16D 127/06; F16D 129/08

(52) U.S. Cl. CPC F16D 65/18; F16D 2121/24; F16D 2127/06; F16D 2129/08

(57) ABSTRACT

A solenoid actuator includes a solenoid driving unit comprising a drive rod, a housing accommodating the solenoid driving unit and having an opening at one side of the housing, and a cover portion coupled to the opening of the housing, wherein the cover portion comprises a body covering the opening of the housing and having a drive hole in which the drive rod of the solenoid drive unit is movable, a parking pawl pivotably coupled to the body and configured to be pivotable in response to movement of the drive rod, and a pawl spring configured to apply an elastic force between the parking pawl and the body.

### CROSS-REFERENCE TO RELATED APPLICATION(S)

This application is based on and claims priority under 35 U.S.C. § 119 to Korean Patent Application No. 10-2025-0033432, filed on Mar. 14, 2025, in the Korean Intellectual Property Office, the disclosure of which is incorporated by reference herein in its entirety.

### BACKGROUND

### Field

The disclosure relates to a solenoid actuator and a brake system comprising the same, and more particularly, to a solenoid actuator with improved assemblability and driving stability, and a brake system comprising the same.

### Description of the Related Art

A brake system is essentially installed in vehicles to perform braking, and various types of brake systems have been proposed to ensure the safety of drivers and passengers.

In conventional brake systems, when a driver presses the brake pedal, hydraulic pressure required for braking is supplied to a wheel cylinder through a mechanically connected booster. However, for the convenience of drivers, electro-mechanical brake systems have been recently developed in which a driver's braking intention is received as an electrical signal, and based on this signal, an electric actuator such as a motor is operated to perform braking of the vehicle.

In such caliper brakes, conventional electric parking brakes (EPBs) used hydraulic service brakes and electric-only parking brakes. In contrast, recent electro-mechanical brakes (EMBs) are implemented to electrically operate both the service brake and the parking brake.

Meanwhile, in the electro-mechanical brake system, a parking gear is used to maintain the parking state of the vehicle during operation of the parking brake. This parking gear is engaged with one of the gear elements provided in the actuator of the brake system to maintain the parking state of the vehicle.

This type of parking gear can be fixed by a solenoid and a parking pawl provided on a bracket coupled to the solenoid. In this case, since the solenoid and the bracket are manufactured separately and then assembled, the bracket may become detached from the solenoid during transportation of the solenoid-bracket assembly. Additionally, if bolts for coupling the solenoid and bracket to the brake housing are not fastened before shipment, the bracket may become disengaged, resulting in the parking gear failing to operate.

### SUMMARY

An embodiment provides a solenoid actuator and a brake system comprising the same, which enhance assemblability and driving stability.

According to one aspect of the disclosure, a solenoid actuator comprises: a solenoid drive unit comprising a drive rod; a housing accommodating the solenoid drive unit therein and having an opening at one side of the housing; and a cover portion coupled to the opening of the housing, wherein the cover portion comprises: a body covering the opening of the housing and having a drive hole in which the drive rod of the solenoid drive unit is movable; a parking pawl pivotably coupled to the body and configured to be pivotable in response to movement of the drive rod; and a pawl spring configured to apply an elastic force between the parking pawl and the body.

The cover portion may be press-fitted to the housing.

The housing may include an inner space accommodating the solenoid drive unit, and the body may include a press-fit portion protruding outward to be press-fitted to an inner surface of the inner space of the housing.

The housing may include a first flange portion extending outward from the opening in a direction perpendicular to a direction of driving the drive rod, and a first coupling hole formed at the first flange portion, and the body may include a second flange portion extending to face the first flange portion of the housing and a second coupling hole formed at a position corresponding to the first coupling hole of the housing.

The body of the cover portion may have a magnetic material.

The body may have a sintered material.

The solenoid actuator may further comprise a bushing member configured to guide the movement of the drive rod and may be coupled to the drive hole of the body of the cover portion.

The solenoid drive unit may further comprise a coil, a bobbin, an armature, and a solenoid spring, and the body may include a protruding guide portion projecting, positioned inside the bobbin and surrounding a portion of the drive rod.

The solenoid spring may be a coil spring having a coil portion disposed outside the protruding guide portion of the body of the cover portion.

The protruding guide portion of the body of the cover portion may have a stepped portion on which one end of the coil portion is seated.

The protruding guide portion of the body of the cover portion may include a first inclined portion at a protruding end of the protruding guide portion, and the armature may include a second inclined portion formed at an end of the armature facing the first inclined portion of the protruding guide portion.

According to another aspect of the disclosure, a brake system comprises a power transmission unit configured to transmit a rotational driving force of a motor to a pressing unit configured to press brake pads provided on both sides of a disc, and a ratchet unit configured to prevent reverse operation of the power transmission unit, wherein the ratchet unit comprises: a ratchet gear configured to rotatable in response to rotation of the motor; and a solenoid actuator configured to move a parking pawl configured to engageable with the ratchet gear, wherein the solenoid actuator comprises: a solenoid drive unit comprising a drive rod; a housing accommodating the solenoid drive unit therein and having an opening at one side of the housing; and a cover portion coupled to the opening of the housing, wherein the cover portion comprises: a body covering the opening of the housing and having a drive hole in which the drive rod of the solenoid drive unit is movable; a parking pawl pivotably coupled to the body and configured to be pivotable in response to movement of the drive rod; and a pawl spring configured to apply an elastic force between the parking pawl and the body.

The cover portion may be press-fitted to the housing.

The housing may include a first flange portion extending outward from the opening in a direction perpendicular to a direction of driving the drive rod and a first coupling hole formed at the first flange portion, and the body may include a second flange portion extending to face the first flange portion of the housing and a second coupling hole formed at a position corresponding to the first coupling hole of the housing.

The brake system may further comprise a brake housing accommodating the solenoid actuator therein and a coupling member passing through the first coupling hole of the housing and the second coupling hole of the body and coupled to the brake housing to fix the solenoid actuator to the brake housing.

The body may have a magnetic material.

The solenoid drive unit may further comprise a coil, a bobbin, an armature, and a solenoid spring, and the body may include a protruding guide portion projecting, positioned inside the bobbin and surrounding a portion of the drive rod.

The solenoid spring may be a coil spring having a coil portion disposed outside the protruding guide portion of the body of the cover portion.

The protruding guide portion of the body of the cover portion may have a stepped portion on which one end of the coil portion is seated.

The protruding guide portion of the body of the cover portion may include a first inclined portion at a protruding end of the protruding guide portion, and the armature may include a second inclined portion formed at an end of the armature facing the first inclined portion the protruding guide portion.

According to the present disclosure, a solenoid actuator and a brake system comprising the same can be provided as a single assembly by directly coupling the parking pawl to the cover of the solenoid actuator.

According to the present disclosure, a solenoid actuator and a brake system comprising the same can improve assemblability and productivity by directly coupling the parking pawl to the cover of the solenoid actuator.

According to the present disclosure, a solenoid actuator and a brake system comprising the same can enhance the driving efficiency of the solenoid actuator by forming the cover of the solenoid actuator using a soft magnetic material.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a perspective view schematically illustrating a brake system according to a first embodiment of the disclosure.

FIG. 2 is a front view schematically illustrating a ratchet unit according to the first embodiment of the disclosure.

FIG. 3 is an exploded perspective view schematically illustrating a cover portion according to the first embodiment of the disclosure.

FIG. 4 is an exploded perspective view schematically illustrating a solenoid actuator according to the first embodiment of the disclosure.

FIG. 5 is an exploded cross-sectional view schematically illustrating a solenoid actuator according to the first embodiment of the disclosure.

FIG. 6 is a cross-sectional view schematically illustrating a solenoid actuator according to the first embodiment of the disclosure.

FIG. 7 is a cross-sectional view schematically illustrating a solenoid actuator coupled to a brake housing according to the first embodiment of the disclosure.

FIG. 8 is a cross-sectional view schematically illustrating a solenoid actuator according to a second embodiment of the disclosure.

### DETAILED DESCRIPTION

Hereinafter, embodiments of the disclosure will be described in detail with reference to the accompanying drawings. The following embodiments are provided to sufficiently transfer the concepts of the present disclosure to one of ordinary skill in the technical art to which the disclosure belongs. However, the present disclosure is not limited to these embodiments, and may be embodied in another form. In the drawings, parts that are irrelevant to the descriptions may be not shown in order to clarify the present disclosure, and also, for easy understanding, the sizes of components are more or less exaggeratedly shown.

Hereinafter, an operation principle and embodiments of the disclosure will be described with reference to the accompanying drawings.

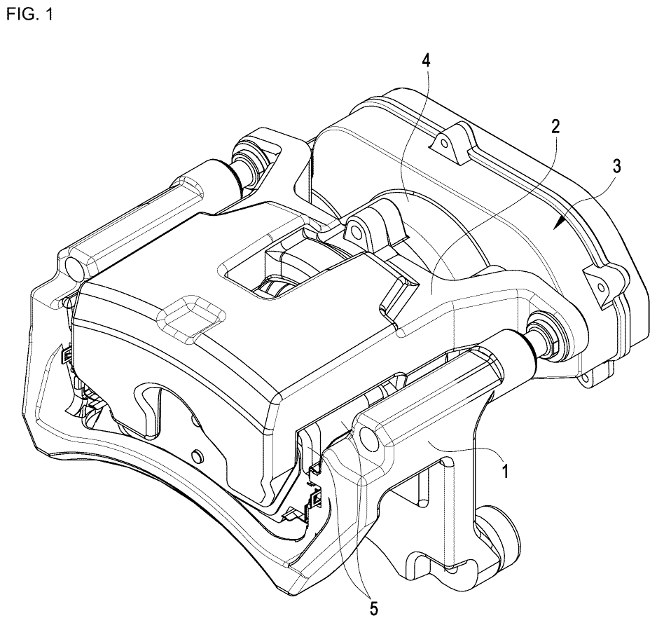

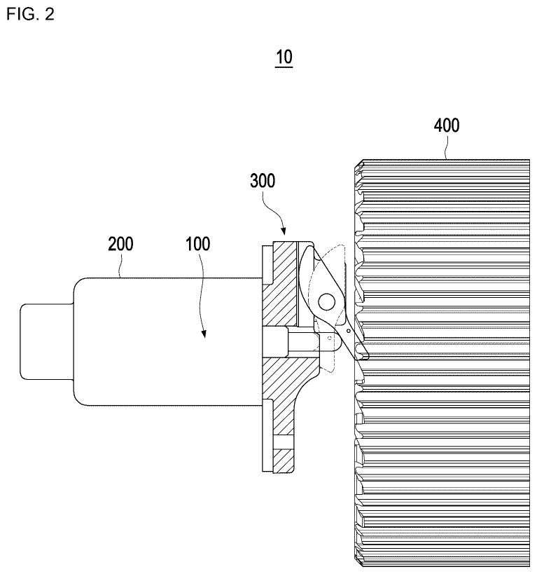

FIG. 1 is a perspective view schematically illustrating a brake system according to a first embodiment of the disclosure, and FIG. 2 is a front view schematically illustrating a ratchet unit according to the first embodiment of the disclosure.

The brake system according to the first embodiment of the disclosure includes a power transmission unit configured to transmit a rotational driving force of a motor to a pressing unit configured to press brake pads 5 provided on both sides of a disc, and a ratchet unit configured to prevent reverse operation of the power transmission unit.

As shown in FIGS. 1 and 2, the brake system may be a disc brake system in which brake pads 5 are provided on both sides of a disc, and may include a caliper housing 2, a carrier 1, a motor that provides the driving force, a pressing unit 4 that presses the brake pads 5, a power transmission unit 3 that transmits the rotational driving force of the motor to the pressing unit, and a ratchet unit 10 that prevents reverse operation of the power transmission unit 3.

The caliper housing 2 serves as the external frame of the brake system. It is typically made of metal and protects and supports the brake pads 5 and the pressing unit 4. The caliper housing 2 is positioned around the disc of the disc brake and holds the brake pads 5 close to the disc.

The disc rotates along with the vehicle wheel, and brake pads 5 are provided on both sides of the disc.

The carrier 1 is a component positioned inside the caliper housing 2 and provides a mechanism for supporting and moving the brake pads 5. The carrier 1 controls the movement of the brake pads 5 to contact or separate from the disc and transmits the clamping force of the brake pads 5 to the disc.

The pressing unit 4 is a device that presses the brake pads 5 toward the disc. Typically, the pressing unit 4 operates when the brake pedal is pressed, generating pressure using hydraulic or electro-mechanical principles. The generated pressure is transmitted to a piston or cylinder inside the caliper housing 2, thereby pressing the brake pads 5 against the disc.

The above-described configuration is a general structure of a disc brake system and is a known technique easily implemented by those skilled in the art, so detailed explanation is omitted.

The motor provides rotational driving force. It is disposed at the rear of the caliper housing 2 and on the side of the power transmission unit 3, and delivers the rotational driving force to the power transmission unit 3.

The power transmission unit 3 transmits the rotational driving force of the motor to the pressing unit 4. The power transmission unit 3 may include a plurality of gears.

That is, in the brake system according to the present embodiment, braking is performed by transmitting the driving force of the motor to the pressing unit 4 through the power transmission unit 3, thereby pressing the brake pads 5. An electric control unit (ECU) for controlling the motor may rotate the motor forward to press the brake pads 5 or rotate the motor in reverse to release the pressing of the brake pads 5.

The ratchet unit 10 prevents reverse operation of the power transmission unit 3. Unlike conventional electric parking brakes, the electro-mechanical brake system electrically implements both the service brake and the parking brake, and thus requires a short operating time.

Therefore, the electro-mechanical brake system employs ball screw spindles instead of traditional lead screw spindles to reduce the operation time. However, such ball screws are prone to reverse rotation issues. The ratchet unit 10 is provided on the power transmission unit 3 to solve such reverse rotation problems.

Referring to FIG. 2, the ratchet unit 10 may include a ratchet gear 400 configured to be rotatable in response to rotation of the motor and a solenoid actuator configured to move a parking pawl 320 configured to be engageable with the ratchet gear 400.

The ratchet gear 400 is rotatable in response to rotation of the motor. The ratchet gear 400 may be a component of the power transmission unit 3 or may be configured to rotate in connection with the power transmission unit 3.

The ratchet gear 400 is rotated by the motor and formed in the shape of a ratchet wheel. A ratchet wheel has unidirectional teeth around its perimeter that allow rotation in one direction but restrict rotation in the opposite direction by a stopper such as the parking pawl 320.

The solenoid actuator may include a solenoid drive unit 100, a housing 200 that accommodates the solenoid drive unit 100, and a cover portion 300 coupled to the housing 200.

The solenoid drive unit 100 is driven by an electrical signal to move the parking pawl 320 so that the parking pawl 320 engages with the ratchet gear 400. Once the parking pawl 320 is engaged with the ratchet gear 400, the rotation of the ratchet gear 400 is restricted, and as a result, the motor and the power transmission unit 3 are fixed.

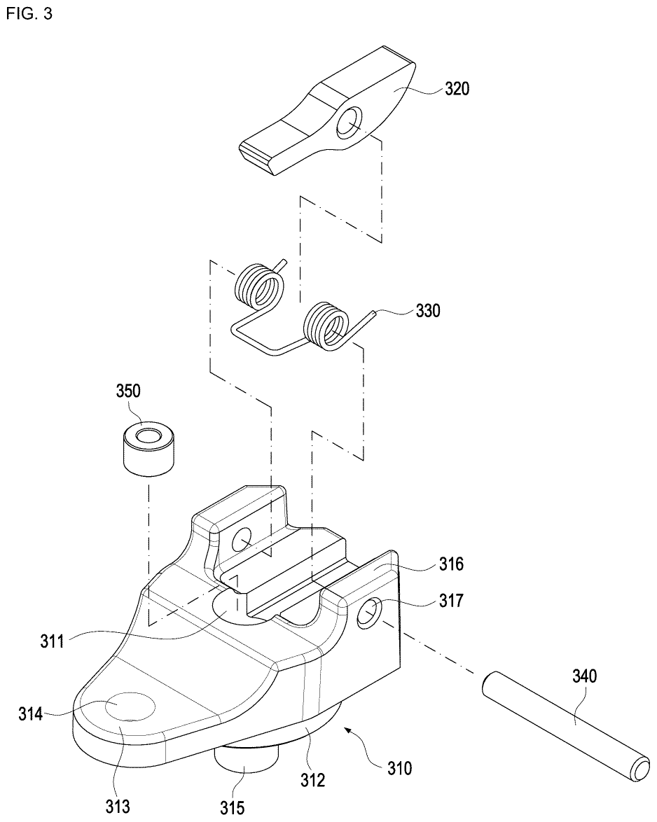

The configuration and operation of the solenoid actuator will now be described in detail with reference to FIGS. 3 to 6.

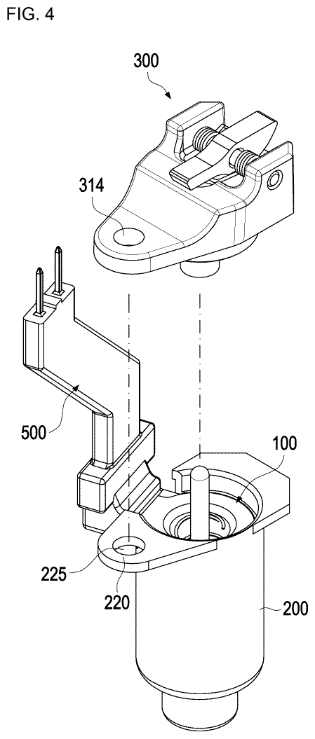

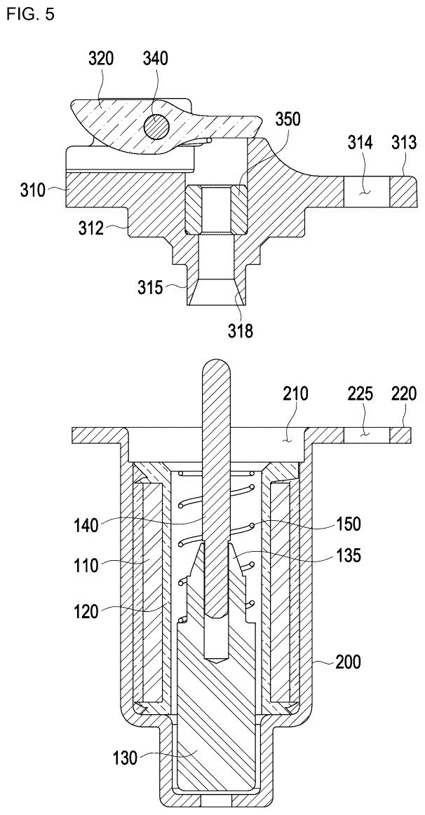

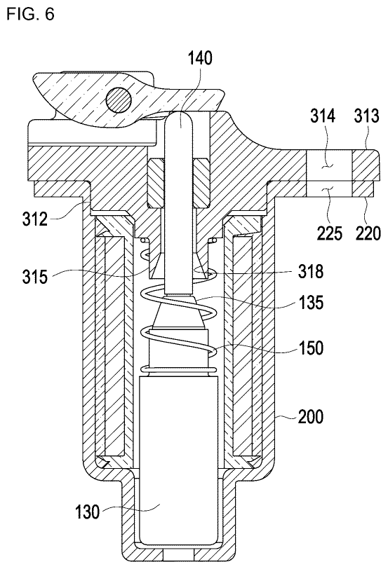

FIG. 3 is an exploded perspective view schematically illustrating a cover portion according to the first embodiment of the disclosure, FIG. 4 is an exploded perspective view schematically illustrating a solenoid actuator according to the first embodiment, FIG. 5 is an exploded cross-sectional view, and FIG. 6 is a cross-sectional view.

As described above, the solenoid actuator includes the solenoid drive unit 100, the housing 200, and the cover portion 300.

The solenoid actuator may further include a terminal portion 500 for electrically connecting the solenoid drive unit 100 to an external device in order to supply power to the solenoid drive unit 100.

The terminal portion 500 may be connected through an opening provided on one side of the housing 200 to link the solenoid drive unit 100 inside the housing 200 with an external device outside the housing 200.

The solenoid drive unit 100 may include a coil 110, a bobbin 120 on which the coil 110 is wound, an armature 130 that is movably inserted into a through-hole of the bobbin 120, a drive rod 140 that is moved by the armature 130, and a solenoid spring 150 that provides a restoring force according to the movement of the armature 130.

The bobbin 120 includes a winding portion where the coil 110 is wound and has a through-hole on its inner surface. The coil 110 generates a magnetic field when power is applied.

The bobbin 120 includes a through-hole into which the armature 130 may be inserted.

The armature 130 is movably inserted into the through-hole to move up and down. The armature 130 is driven up and down by the magnetic field generated by the coil 110. Preferably, the armature 130 is formed of a magnetic material.

The drive rod 140 may be coupled to the armature 130. The drive rod 140 moves according to the armature 130 and may apply force to an external device via an end protruding outward.

Preferably, one end of the drive rod 140 protrudes to the outside of the housing 200 to press the parking pawl 320 toward the ratchet gear 400, so that the parking pawl 320 engages with the ratchet gear 400.

The housing 200 accommodates the solenoid drive unit 100 and may have an opening in a direction of driving the drive rod 140, i.e., in the upward direction in FIGS. 3 to 6. Through this opening, the solenoid drive unit 100 can be inserted into the housing 200 during manufacturing of the solenoid actuator.

The cover portion 300 is coupled to the opening of the housing 200 and covers the opening. The cover portion 300 not only protects the solenoid drive unit 100 accommodated in the housing 200 by covering the opening, but also serves as a bracket for rotatably fixing the parking pawl 320.

The cover portion 300 includes a body 310 that covers the opening of the housing 200 and has a drive hole 311 in which the drive rod 140 is movable, a parking pawl 320 that is pivotably coupled to the body 310 in response to movement of the drive rod 140, and a pawl spring 330 configured to apply an elastic force between the parking pawl 320 and the body 310.

A bushing member 350 guiding the movement of the drive rod 140 may be coupled to the drive hole 311. The bushing member 350 may be press-fitted into the drive hole 311 to contact the outer surface of the drive rod 140, thereby guiding its movement along the drive axis and reducing friction.

The body 310 covers the opening of the housing 200, and the parking pawl 320 is pivotably coupled to the body 310. For this, the parking pawl 320 may be coupled to the body 310 via a rotation shaft 340.

In this case, the body 310 may include a pair of rotational coupling protrusions 316 protruding in the direction of the parking pawl 320, and each of the pair of rotational coupling protrusions 316 may have a rotational coupling hole 317.

The rotation shaft 340 passes through the rotational coupling holes 317 and connects to the parking pawl 320, thereby allowing the parking pawl 320 to be pivotably coupled to the body 310.

The pawl spring 330 applies an elastic force between the parking pawl 320 and the body 310.

When the solenoid drive unit 100 is actuated, one end of the parking pawl 320 may engage with the teeth of the ratchet gear 400. At this time, the pawl spring 330 may provide an elastic force that separates the parking pawl 320 from the ratchet gear 400.

Accordingly, when the pressure from the solenoid drive unit 100 is released, the parking pawl 320 may be disengaged from the teeth of the ratchet gear 400 by the restoring force of the pawl spring 330.

The pawl spring 330 may be provided as a torsion spring. Preferably, the pawl spring 330 may be configured as a double torsion spring.

The cover portion 300 may be press-fitted to the housing 200. As a result, the cover portion 300 protects the solenoid drive unit 100 accommodated in the housing 200 and integrates the solenoid actuator as a single assembly.

In this manner, the body 310 coupled to the parking pawl 320 is press-fitted to the opening of the housing 200, thereby coupling the parking pawl 320 as part of the solenoid actuator assembly. Consequently, during transportation in the assembled form, separation of the solenoid drive unit 100 and the parking pawl can be prevented.

Furthermore, as described later, when fixing the solenoid actuator assembly to the brake housing 20, secure fixation is possible using only a single coupling member 30, preventing missed fastening during assembly.

The housing 200 may include an inner space 210 that accommodates the solenoid drive unit 100, and the body 310 may include a press-fit portion 312 protruding outward to be press-fitted to the inner surface of the inner space 210.

Preferably, the inner space 210 has a cylindrical shape overall, and the press-fit portion 312 also protrudes from the body 310 in a cylindrical shape such that the outer surface of the cylindrical press-fit portion can be press-fitted into the inner surface of the inner space 210.

The housing 200 may further include a first flange portion 220 extending outward from the opening in a direction perpendicular to the direction of driving the drive rod 140 (i.e., vertical direction in FIGS. 3 to 6), and a first coupling hole 225 may be formed at the first flange portion 220. These elements may be used to fix the solenoid actuator to the brake housing 20 of the brake system.

The body 310 may include a second flange portion 313 extending to face the first flange portion 220, and a second coupling hole 314 may be formed at a position corresponding to the first coupling hole 225.

The second flange portion 313 and the second coupling hole 314 may firmly couple the housing 200 and the cover portion 300, and may also be used to fix the solenoid actuator to the brake housing 20 of the brake system.

The fixation of the solenoid actuator by the first coupling hole 225 and the second coupling hole 314 will be described later.

The body 310 includes a protruding guide portion 315 that protrudes inward into and positioned inside the bobbin 120 and surrounds a portion of the drive rod 140.

The protruding guide portion 315 improves the operational stability of the drive rod 140 by surrounding its outer surface. Since the protruding guide portion 315 protrudes into the inside of the bobbin 120, the inner circumferential surface area facing the outer surface of the drive rod 140 can be increased. By increasing this area, the drive rod 140 can move along the axis without deviating from it during operation.

As shown in FIG. 6, the solenoid spring 150 may be a coil spring, and the coil portion of the spring may be disposed outside the protruding guide portion 315.

To securely fix the solenoid spring 150, a step portion on the outside of the protruding guide portion 315 may be formed, on which one end of the coil portion is seated. By placing the solenoid spring 150 on the outside of the protruding guide portion 315 and seating one end of the coil portion on the step portion, the spring can be prevented from dislodging even when compressed, and the reaction force caused by compression can be appropriately controlled.

Moreover, because the solenoid spring 150 is disposed outside the protruding guide portion 315, the protruding guide portion 315 can secure a larger area of the inner surface that faces the outer surface of the drive rod 140.

Meanwhile, the body 310 may have a sintered material and manufactured by sintering.

As shown, the body 310 has a complex shape including a drive hole 311 in which the drive rod 140 penetrates, a press-fit portion 312 press-fitted into the housing 200, a second flange portion 313 and a second coupling hole 314 for coupling with the housing 200 and the brake housing 20, a protruding guide portion 315 inserted into the bobbin 120, and a rotational coupling protrusion 316 and rotational coupling hole 317 for coupling the parking pawl 320.

To manufacture the body 310 with such a complex shape, it may be sintered using a sintered material. Through the sintering process, the body 310 can be manufactured in a complex shape to fulfill its role of covering the opening of the housing 200 and serving as a bracket for the parking pawl 320.

Meanwhile, the body 310 may have a soft magnetic material.

As described above, the body 310 not only covers the opening of the housing 200, but the protruding guide portion 315 is also inserted into the bobbin 120. The protruding guide portion 315 serves to guide the magnetic field generated by the coil 110 so that the armature 130 is actuated by the magnetic field when power is supplied to the coil 110. To this end, the body 310 may have a soft magnetic material.

Meanwhile, if the surfaces of the armature 130 and the protruding guide portion 315 that face each other are flat, the magnetic force between them may increase rapidly as the armature 130 approaches the protruding guide portion 315, possibly causing impact during the upward movement of the armature 130.

Accordingly, in the first embodiment of the disclosure, the protruding guide portion 315 may include a first inclined portion 318, which is inclined at least partially at its protruding end, and the armature 130 may include a second inclined portion 135 inclined at an angle corresponding to the first inclined portion 318 at the end facing the protruding guide portion 315.

As shown in FIGS. 5 and 6, the first inclined portion 318 has an inclined outer surface forming a concave shape, and the second inclined portion 135 has an outer surface at an angle corresponding to the first inclined portion 318, forming a convex shape facing the outer surface of the first inclined portion 318.

The second inclined portion 135 may be configured such that, when the armature 130 moves upward, it is inserted into the interior of the first inclined portion 318 and faces or contacts the first inclined portion 318.

When the armature 130 approaches the protruding guide portion 315, the second inclined portion 135 is inserted into the first inclined portion 318, and the lower end of the first inclined portion 318 and the upper end of the second inclined portion 135 partially overlap. Accordingly, the magnetic force received by the armature 130 due to the magnetic field induced by the protruding guide portion 315 does not increase sharply, and the armature 130 can move upward under a stable magnetic force.

Meanwhile, the solenoid actuator must be fixed at a predetermined position inside the brake housing 20 of the brake system in order to be fastened to the ratchet gear 400 connected to the power transmission unit 3 of the brake system.

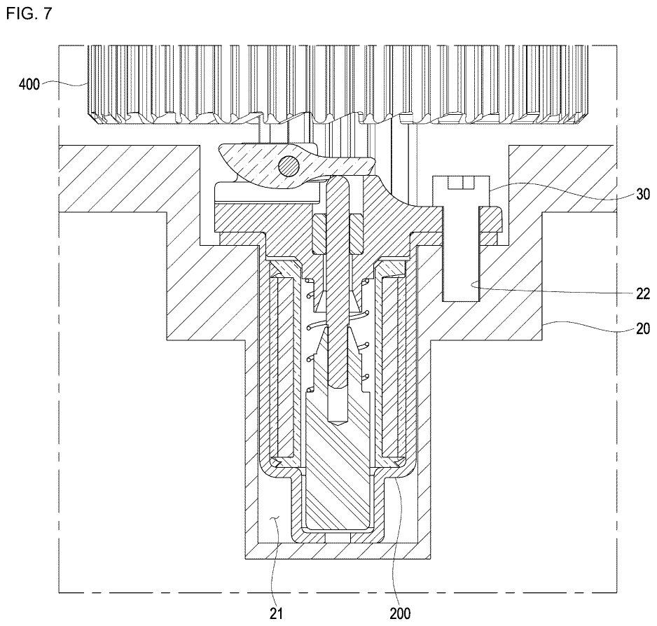

FIG. 7 is a schematic cross-sectional view showing the solenoid actuator coupled to a brake housing according to the first embodiment of the disclosure.

Referring to FIG. 7, the brake system may further include a brake housing 20 that accommodates the solenoid actuator therein and a coupling member 30 that fixes the solenoid actuator to the brake housing.

The brake housing 20 may be configured to accommodate components of the brake system therein. For example, the brake housing 20 may be formed as a housing that accommodates the power transmission unit 3 shown in FIG. 1.

The brake housing 20 may include a receiving space 21 in which the solenoid actuator is mounted and accommodated. The outer surface of the housing 200 of the solenoid actuator contacts the inner surface of the receiving space 21, allowing the solenoid actuator to be seated in the receiving space 21.

The receiving space 21 is provided on a surface facing the ratchet gear 400 housed within the brake housing 20 so that the parking pawl 320 can be engaged with the ratchet gear 400 when the solenoid actuator is actuated.

As previously described, the first flange portion 220 of the housing 200 includes a first coupling hole 225, and the second flange portion 313 of the cover portion 300 includes a second coupling hole 314. These first coupling hole 225 and second coupling hole 314 are provided at corresponding positions such that when the housing 200 and the cover portion 300 are coupled, the first coupling hole 225 and the second coupling hole 314 are aligned on the same axis.

The coupling member 30 passes through the aligned first coupling hole 225 and second coupling hole 314 and coupled to the brake housing 20, thereby allowing the solenoid actuator to be fixed to the brake housing 20.

For example, the coupling member 30 may be a bolt that passes through the first coupling hole 225 and second coupling hole 314 and is fastened to a third coupling hole 22 of the brake housing 20. The bolt thread of the coupling member 30 engages with the thread of the third coupling hole 22, and the bolt head of the coupling member 30 presses the second flange portion 313 from above the second coupling hole 314 so that the second flange portion 313 is pressed toward the brake housing 20. In this case, the second flange portion 313 also presses the first flange portion 220 so that both the first flange portion 220 and the second flange portion 313 can be fixed.

Through such a coupling member 30, the solenoid actuator can not only be fixedly coupled to the brake housing 20 but also the coupling between the housing 200 and the cover portion 300 of the solenoid actuator can be reinforced.

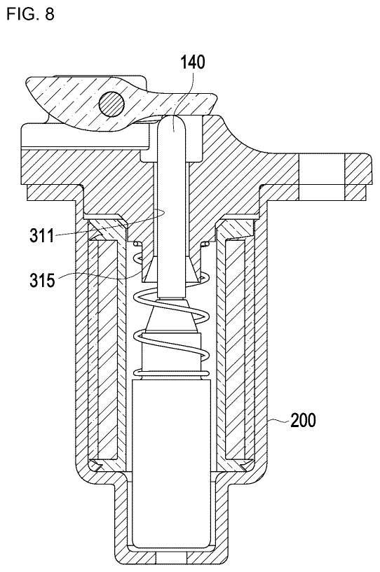

Hereinafter, a solenoid actuator according to a second embodiment of the disclosure will be described with reference to FIG. 8. The description of components of the solenoid actuator according to the second embodiment that are identical to those of the first embodiment will be omitted.

FIG. 8 is a schematic cross-sectional view of a solenoid actuator according to a second embodiment of the disclosure.

The solenoid actuator according to the second embodiment of the disclosure may include a solenoid driving unit 100, a housing 200 that accommodates the solenoid driving unit 100, and a cover portion 300 that is coupled to the housing 200, similarly to the first embodiment.

The cover portion 300 may include a body 310 that covers the opening of the housing 200 and is provided with a drive hole 311 through which the drive rod 140 is inserted, a parking pawl 320 pivotably coupled to the body 310 according to movement of the drive rod 140, and a pawl spring 330 configured to apply elastic force between the parking pawl 320 and the body 310.

Unlike the first embodiment, the cover portion 300 according to the second embodiment does not include a bushing member 350. Instead of the bushing member 350, the drive hole 311 of the cover portion 300 according to the second embodiment has a longer axial shape than that of the first embodiment.

The drive hole 311 is formed to penetrate from the protruding guide portion 315 to the upper end of the body 310. The inner circumferential surface of the drive hole 311 is arranged to surround the outer circumferential surface of the drive rod 140, thereby guiding the drive rod 140 during operation along the drive axis. When the length of the drive hole 311 is extended, the operational stability of the drive rod 140 can be improved. By increasing the length of the drive hole 311, the area of the inner surface facing the outer surface of the drive rod 140 can be increased, and the drive rod 140 can move along the axis without deviating from it.

What is claimed is:

1. A solenoid actuator comprising:
a solenoid drive unit comprising a drive rod;
a housing accommodating the solenoid drive unit therein and having an opening at one side of the housing; and
a cover portion coupled to the opening of the housing,
wherein the cover portion comprises:
a body covering the opening of the housing and having a drive hole in which the drive rod of the solenoid drive unit is movable;
a parking pawl pivotably coupled to the body and configured to be pivotable in response to movement of the drive rod; and
a pawl spring configured to apply an elastic force between the parking pawl and the body.

2. The solenoid actuator of claim 1, wherein the cover portion is press-fitted to the housing.

3. The solenoid actuator of claim 2, wherein:
the housing includes an inner space accommodating the solenoid drive unit; and
the body includes a press-fit portion protruding outward to be press-fitted to an inner surface of the inner space of the housing.

4. The solenoid actuator of claim 1, wherein:
the housing includes a first flange portion extending outward from the opening in a direction perpendicular to a direction of driving the drive rod, and a first coupling hole formed at the first flange portion, and
the body includes a second flange portion extending to face the first flange portion of the housing and a second coupling hole formed at a position corresponding to the first coupling hole of the housing.

5. The solenoid actuator of claim 1, wherein the body of the cover portion has a magnetic material.

6. The solenoid actuator of claim 1, wherein the body has a sintered material.

7. The solenoid actuator of claim 1, further comprising a bushing member configured to guide the movement of the drive rod and coupled to the drive hole of the body of the cover portion.

8. The solenoid actuator of claim 1, wherein:
the solenoid drive unit further comprises a coil, a bobbin, an armature, and a solenoid spring; and
the body includes a protruding guide portion projecting, positioned inside the bobbin and surrounding a portion of the drive rod.

9. The solenoid actuator of claim 8, wherein the solenoid spring is a coil spring having a coil portion disposed outside the protruding guide portion of the body of the cover portion.

10. The solenoid actuator of claim 9, wherein the protruding guide portion of the body of the cover portion has a stepped portion on which one end of the coil portion is seated.

11. The solenoid actuator of claim 8, wherein:
the protruding guide portion of the body of the cover portion includes a first inclined portion at a protruding end of the protruding guide portion, and
the armature includes a second inclined portion formed at an end of the armature facing the first inclined portion of the protruding guide portion.

12. A brake system comprising:
a power transmission unit configured to transmit a rotational driving force of a motor to a pressing unit configured to press brake pads provided on both sides of a disc; and
a ratchet unit configured to prevent reverse operation of the power transmission unit,
wherein the ratchet unit comprises:
a ratchet gear configured to be rotatable in response to rotation of the motor; and
a solenoid actuator configured to move a parking pawl configured to be engageable with the ratchet gear,
wherein the solenoid actuator comprises:
a solenoid drive unit comprising a drive rod;
a housing accommodating the solenoid drive unit therein and having an opening at one side of the housing; and
a cover portion coupled to the opening of the housing,
wherein the cover portion comprises:
a body covering the opening of the housing and having a drive hole in which the drive rod of the solenoid drive unit is movable;
a parking pawl pivotably coupled to the body and configured to be pivotable in response to movement of the drive rod; and
a pawl spring configured to apply an elastic force between the parking pawl and the body.

13. The brake system of claim 12, wherein the cover portion is press-fitted to the housing.

14. The brake system of claim 12, wherein:
the housing includes a first flange portion extending outward from the opening in a direction perpendicular to a direction of driving the drive rod, and a first coupling hole formed at the first flange portion, and
the body includes a second flange portion extending to face the first flange portion of the housing and a second coupling hole formed at a position corresponding to the first coupling hole of the housing.

15. The brake system of claim 14, further comprising:
a brake housing accommodating the solenoid actuator therein; and
a coupling member passing through the first coupling hole of the housing and the second coupling hole of the body and coupled to the brake housing to fix the solenoid actuator to the brake housing.

16. The brake system of claim 12, wherein the body has a magnetic material.

17. The brake system of claim 12, wherein:
the solenoid drive unit further comprises a coil, a bobbin, an armature, and a solenoid spring; and
the body includes a protruding guide portion projecting, positioned inside the bobbin and surrounding a portion of the drive rod.

18. The brake system of claim 17, wherein the solenoid spring is a coil spring having a coil portion disposed outside the protruding guide portion of the body of the cover portion.

19. The brake system of claim 18, wherein the protruding guide portion of the body of the cover portion has a stepped portion on which one end of the coil portion is seated.

20. The brake system of claim 17, wherein the protruding guide portion of the body of the cover portion includes a first inclined portion at a protruding end of the protruding guide portion, and
the armature includes a second inclined portion formed at an end of the armature facing the first inclined portion of the protruding guide portion.
